(19) United States
(12) Patent Application Publication
(10) Pub. No.: US 2009/0094200 A1
(43) Pub. Date: Apr. 9, 2009

(54) Method for Admission-controlled Caching

(75) Inventors: Ricardo Baeza-Yates, Barcelona (ES); Flavio Junqueira, Barcelona (ES); Vassilis Plachouras, Barcelona (ES); Hans Friedrich Witschel, Leipzig (DE)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/868,396

(22) Filed: Oct. 5, 2007

(51) Int. Cl. G06F 17/30

(52) U.S. Cl. 707/3; 707/E17.108

(57) ABSTRACT

A method of caching the results of a search engine query divides a search engine cache into two parts, controlled and uncontrolled, and determines, through an admission policy, to which part the query results should be cached. In one implementation, the admission policy estimates whether a query is likely to be frequent or infrequent in the future by analyzing various features of the query.

### BACKGROUND

1. Field of the Invention

Aspects of the present invention relate generally to using an admission policy to control the caching of search engine results.

2. Description of Related Art

As is known in the art, search engines enable users to find content available through a wide variety of mediums and protocols, such as, for example, the Internet and the Hypertext Transfer Protocol (HTTP), etc. On a regular basis, the majority of Internet users submit search queries to search engines when looking for specific content on the Internet. Given the large number of users routinely searching for content, the large volume of data required to enable useful results, and the high processing requirements of such a search engine system, efficient mechanisms are needed to enable search engines to respond to the queries as quickly and efficiently as possible.

One mechanism for increasing the efficiency of processing search engine queries is a cache, which can maintain, in some medium, the results of frequently or recently submitted queries. Generally, a cache allocates a fixed, pre-determined amount of memory space, where it stores previously processed search queries. If a search engine then receives a query (or an element of a query) that it has already processed and stored in the cache, the cached results may be returned without having to re-process the query (or query element); such an action is known as a “hit” (the performance of a cache is generally measured in terms of a “hit ratio,” which is the number of hits divided by the total number of queries). If a search engine receives a query that it has not already processed, or, more specifically, that it has not already processed and saved to the cache (a “miss”), then it processes the query and [potentially] saves the results to the cache.

If the cache is full when new results need to be saved to it, an eviction policy may be employed to determine what, if anything, will be removed from the cache so that room can be made for the new results. Various eviction policies are known in the art, but they are generally not used in conjunction with an admission policy that takes into account the frequency of the queries, and, as a result, the cache memory may be filled with results that may not correspond to “hits” before they are evicted (i.e., the query may appear so infrequently as to render its time in the cache useless). Using only an eviction policy, the query results for all queries are admitted to the cache, including those that will never appear again; these query results can be said to “pollute” the cache because they use cache space, but do not generate any cache hits.

Thus, it would be desirable, when evaluating a particular query, to use an estimator that predicts whether the query is infrequent or frequent, and caches accordingly.

### SUMMARY

In light of the foregoing, it is a general object of the present invention to combine an admission policy with an eviction policy, where the admission policy determines where in the cache the results of a query should be stored.

### BRIEF DESCRIPTION OF THE DRAWING FIGURES

FIG. 1 is a logical flowchart illustrating the general process by which an admission policy is implemented in the caching sequence.

### DETAILED DESCRIPTION

Detailed descriptions of one or more embodiments of the invention follow, examples of which may be graphically illustrated in the drawing. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

Aspects of the present invention are described below in the context of search engine caches and an admission policy used to determine what and where query results should be cached.

Throughout this disclosure reference is made to a “cache,” which generally comprises a memory space and an implementation of a management policy; cache memories are limited in size, and so it is necessary to evict entries when the cache is full and there is a new entry to add. As understood by those of skill in the art, a search engine cache may be implemented through any of several mediums, such as, for example, Random-Access Memory (RAM), hard disks, hard disk arrays, etc. While the medium used is non-critical with respect to the invention, it will be appreciated by those of skill in the art that the methods described herein are applicable to all levels of the data-access hierarchy (e.g., memory/disk layer, etc.). It also will be understood by those of skill in the art that a cache may span multiple disks, locations, etc.

Caches, as implemented by search engines, are generally described as being either “static” or “dynamic,” which roughly correlates to when and how the cache is filled. A static cache is based on historical information and is periodically updated. The historical information may be informed by a query log, which maintains statistics about the frequency of query terms over a defined period. The decision as to what to cache in a static caching system may be considered as happening “offline” (i.e., it does not happen in real-time as new queries are received). Given that the most popular queries (i.e., those which occur most frequently) change infrequently, it is possible to keep track of them and make sure they are cached; the cache can periodically be brought up-to-date by re-calculating, offline, the most popular queries in the query log, on the assumption that query frequencies do not change much between the “learning” period (i.e., the period over which the queries in the query log are being examined) and the “deployment” period (i.e., when the cache is actively being used by the search engine).

Dynamic caching replaces cache entries according to the [real-time] sequence of queries received by the search engine; when a new request arrives, the cache system decides whether to evict some entry from the cache in the case of a cache miss (i.e., where the entry related to the current request does not exist in the cache). Such “online” decisions are based on a cache management policy, which can be configured in any of a number of different ways, as discussed below.

As is known in the art, most search engine queries are submitted only a few times or even just once, and thus caching the results for these queries is inefficient because they are unlikely to result in hits, and they use memory space, which could be used for other, more frequent queries that are more likely to take advantage of the cached data.

The invention, an admission-controlled cache, comprises an admission policy to improve hit rate by discarding the results of infrequent queries, or rather storing their results in a part of the cache separate from the results of frequent queries; thus, an admission-controlled cache can be used to improve the average response time because more queries can be answered by serving already-computed results. An admission-controlled cache may be split into two parts, a “controlled” cache, and an “uncontrolled” cache. Generally, the admission policy admits query results to the controlled cache if the query is determined to be frequent, or rather, a future cache hit; it stores query results to an “uncontrolled” cache where the query is predicted to be infrequent in the future. For example, frequent queries such as “car loan” may be stored in the controlled cache, whereas the query “car lean,” which is an infrequent spelling mistake of the previous query, may be stored in the uncontrolled cache. The admission policy element helps to ensure that frequent queries are protected from being evicted due to the high number of infrequent queries submitted to search engines.

It will be appreciated that, ideally, there would be no need for the uncontrolled cache; however, implementing such an admission control policy is difficult, and if the policy is based on, for example, query frequency, then its estimation on hits and misses will not be perfect due to the temporal locality of some infrequent queries. The uncontrolled cache can therefore handle queries that are infrequent, but appear in short bursts; because the admission policy (using separate caches) will reject from the controlled cache queries that it determines to be infrequent, and because these queries may be asked again by the same user and within a short period of time, the uncontrolled cache can handle them. Thus, an admission policy that leverages separate caches guarantees that fewer infrequent queries enter the controlled cache, which results in better handling of temporal locality.

As discussed above, a cache may be static, dynamic, or a combination of both. In one embodiment, a cache which uses an admission policy may be completely dynamic, which makes it more flexible and easier to adjust in response to changes in the distribution of incoming queries. Like any dynamic cache, an admission-controlled cache must use an eviction policy to decide which stored result(s) will be removed from the cache in order to free memory space for the current result (if there is not currently enough room for the result). Any eviction policy may be used, including those that are well known in the art, such as, for example, least recently used (i.e., the item(s) least recently accessed by the search engine is removed from the cache), least frequently used (i.e., the item(s) accessed by the search engine the fewest times over some period is removed from the cache), etc.

In one embodiment, the admission policy may predict the future frequency of a query—distinguishing future cache hits from future misses—by comparing the values of features of the query to pre-defined thresholds. A feature in this context may comprise some property of a query that the admission policy may use to determine which part of the cache (controlled or uncontrolled) the query results should be stored. Features may be either stateful or stateless. Stateful features are based on the historical usage information of a search engine, and they generally require extra memory space to hold statistics, which are usually related to the frequency of query strings and sub-strings (e.g., words, etc.). One example of a stateful feature is past query frequency, which may be derived from a query log. If a frequency is higher than a pre-defined threshold, then an admission policy may store the query results to the controlled cache; otherwise, the query results may be stored to the uncontrolled cache. For example, if the threshold for the past frequency of a query is 10, and a particular query appears 40 times in a set of past queries, then the admission policy may store the results to the controlled cache.

Stateless features are those that can be readily deduced from a query, in real-time, without making use of collected information. One example of a stateless feature is query length, which may be a function of either the number of words in the query or the number of characters. Irrespective of the basis for the metric, if the “length” of the query is higher than a pre-defined threshold, then an admission policy may store the query results to the uncontrolled cache; otherwise, the query results may be saved to the controlled cache. For example, if the threshold for the query length, as measured in words, is two, then the query, “email,” is stored to the controlled cache, and the query, “email client download,” is stored to the uncontrolled cache (i.e., “email” is only one word, and “email client download” is three).

Another example of a stateless feature that may be taken into account by an admission policy is the number of non-alphanumeric characters in a query. Non-alphanumeric characters may comprise those characters that do not correspond to a letter, a numerical digit, a space character, or a quote. If the number of non-alphanumeric characters is higher than a pre-defined threshold, then an admission policy may store the query results to the uncontrolled cache; otherwise, the query results may be stored to the controlled cache. For example, if the threshold for the number of non-alphanumeric characters is three, then the admission policy may store the results of the query, “e-mail@domain,” to the controlled cache because there is only one non-alphanumeric character, namely “@.”

Yet another example of a stateless feature is the length of the longest numerical digit sequence in the query. If the length of the longest sequence of numbers is higher than a given threshold, then an admission policy may store the query results to the uncontrolled cache; otherwise, the query results may be stored to the controlled cache. For example, if the threshold for the number of numerical digits appearing in sequence is four, then the admission policy may store the query, “sunnyvale 95050,” to the uncontrolled cache, whereas it may store the query, “area code city 352,” to the controlled cache.

It will be appreciated by those of skill in the art that other features may be used in defining an admission policy and that those discussed above are merely illustrative of certain features that may be helpful in evaluating whether to store query results to either the controlled cache or the uncontrolled cache. It also will be appreciated that the features used to define an admission policy may exist in any combination and structure. For example, an admission policy may take into account five disparate features, treat each of them equally, and decide to which cache to store the query results (either controlled or uncontrolled) depending on values generated by each of the feature evaluations (e.g., if three out of the five features determine that the query results should be cached to the controlled cache, then the admission policy may cache the results to the controlled cache, etc.). As another example, an admission policy may use three features to evaluate a query result, and may ascribe to each feature a different weight, such that the determination by one feature of a certain action counts for more in the overall admission policy than the determination of one of the other features. As still another example, an admission policy may require all of the supported feature determinations to agree before any action is taken (e.g., all of the features must determine that the query result should be cached to the controlled cache, etc.).

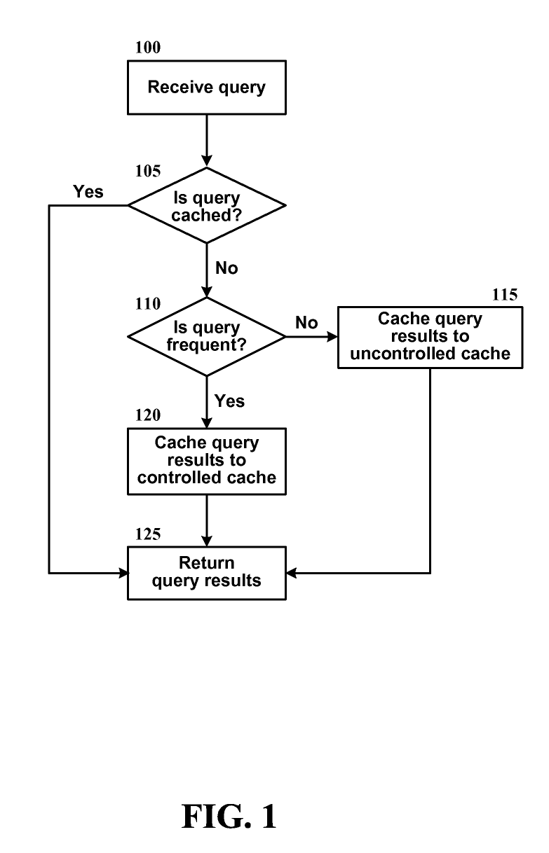

FIG. 1 is a logical flowchart illustrating the general process by which an admission policy is implemented in the caching sequence. As illustrated at block 100, the search engine receives a query. At block 105, it is determined whether the query results already exist in the cache (i.e., the query has been requested before and the results saved); if the query results do already exist in the cache, the search engine reads the results from the cache and returns them (without having to re-compute the results); however, if the query results are not in the cache, then it is determined, at block 110, whether the query is frequent or infrequent. Such a determination may be based on an admission policy as discussed herein. If the admission policy predicts that the query will be infrequent in the future, then the query results may be stored to the uncontrolled cache at block 115; if, however, the admission policy finds the query to be frequent, then its results may be stored to the controlled cache at block 120. After the results have been stored to the cache, the search engine may return them, as illustrated at block 125.

The sequence and numbering of blocks depicted in FIG. 1 is not intended to imply an order of operations to the exclusion of other possibilities. It will be appreciated by those of skill in the art that the foregoing systems and methods are susceptible of various modifications and alterations. For example, it may not always be the case that the query frequency is checked, as shown at block 110, before it is determined whether the results already exist in the cache, as shown at block 105.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of caching the results of a search engine query, said method comprising:
receiving a query;
determining whether the query is frequent based on an admission policy;
caching query results corresponding to the query to either a first dynamic cache or a second dynamic cache in response to said determination.

2. The method of claim 1 wherein the admission policy is defined by at least one of a plurality of features corresponding to the query.

3. The method of claim 2 wherein the plurality of features is selected from the group consisting of:
length of the query,
length of the longest contiguous sequence of numerical digits in the query,
number of non-alphanumeric characters in the query, and
past frequency of the query.

4. The method of claim 3 wherein the length of the query is a function of the number of words in the query.

5. The method of claim 3 wherein the length of the query is a function of the number of characters in the query.

6. The method of claim 3 wherein the past frequency of the query is determined by referencing a past query log.

7. A computer-readable medium encoded with a computer-executable program to perform a method comprising:
receiving a query;
determining whether the query is frequent based on an admission policy;
caching query results corresponding to the query to either a first dynamic cache or a second dynamic cache in response to said determination.

8. The computer-readable medium of claim 7 wherein the admission policy is defined by at least one of a plurality of features corresponding to the query.

9. The computer-readable medium of claim 8 wherein the plurality of features is selected from the group consisting of:
length of the query,
length of the longest contiguous sequence of numerical digits in the query,
number of non-alphanumeric characters in the query, and
past frequency of the query.

10. The computer-readable medium of claim 9 wherein the length of the query is a function of the number of words in the query.

11. The computer-readable medium of claim 9 wherein the length of the query is a function of the number of characters in the query.

12. The computer-readable medium of claim 9 wherein the past frequency of the query is determined by referencing a past query log.
